(19) United States
(12) Patent Application Publication
(10) Pub. No.: US 2005/0200046 A1
(43) Pub. Date: Sep. 15, 2005

(54) Machine-direction oriented multilayer films

(76) Inventor: D. Ryan Breese, Loveland, OH (US)

Correspondence Address: LYONDELL CHEMICAL COMPANY, 3801 WEST CHESTER PIKE, NEWTOWN SQUARE, PA, 19073, US

(21) Appl. No.: 10/797,640

(22) Filed: Mar. 10, 2004

(51) Int. Cl. B29C 55/06; B32B 27/00

(52) U.S. Cl. 264/288.4; 156/344; 428/500; 428/910

(57) ABSTRACT

A method for making films is disclosed. The method comprises orienting in the machine direction a multilayer film at a draw-down ratio effective to give the film a dart-drop strength that increases with increasing draw-down ratio. The multilayer film comprises at least one layer of a linear low density polyethylene and at least one layer of a high density polyethylene or a medium density polyethylene.

### FIELD OF THE INVENTION

The invention relates to polyethylene films. More particularly, the invention relates to machine-direction oriented multilayer films.

### BACKGROUND OF THE INVENTION

Polyethylene is divided into high-density (HDPE, density 0.941 g/cm³ or greater), medium-density (MDPE, density from 0.926 to 0.940 g/cm³), low-density (LDPE, density from 0.910 to 0.925 g/cm³), and linear low-density polyethylene (LLDPE, density from 0.910 to 0.925 g/cm³). See ASTM D4976-98: Standard Specification for Polyethylene Plastic Molding and Extrusion Materials. Polyethylene can also be divided by molecular weight. For instance, ultra-high molecular weight polyethylene denotes those which have a weight average molecular weight (Mw) greater than 3,000,000. See U.S. Pat. No. 6,265,504. High molecular weight polyethylene usually denotes those which have an Mw from 130,000 to 1,000,000.

One of the main uses of polyethylene (HDPE, MDPE, LLDPE, and LDPE) is in film applications, such as grocery sacks, institutional and consumer can liners, merchandise bags, shipping sacks, food packaging films, multi-wall bag liners, produce bags, deli wraps, stretch wraps, and shrink wraps. The key physical properties of polyethylene film include tear strength, impact strength, tensile strength, stiffness and transparency. Film stiffness can be measured by modulus. Modulus is the resistance of the film to deformation under stress.

Machine direction orientation (MDO) is known to the polyolefin industry. When a polymer is strained under uniaxial stress, the orientation becomes aligned in the direction of pull. For instance, U.S. Pat. No. 6,391,411 teaches the MDO of high molecular weight (both Mn and Mw greater than 1,000,000) HDPE films. However, MDO of high molecular weight HDPE films are limited because these films are difficult to stretch to a high draw-down ratio.

The current polyethylene films typically compromise several properties, such as modulus, yield strength, and break strength, to meet the package requirements for dart drop impact strength. Polymer films that do not compromise such properties are desirable for improving the performance of the bags, as well as the economics associated with producing and filling the bags. For example, by increasing the modulus and the yield strength of the film, larger bags can be produced, which would allow packaging larger quantities of goods while retaining their shape after being handled by the consumer. Bags with higher modulus would also allow the filling lines to run faster, improving the overall economics of the filling process.

By increasing the yield strength of the film, the bags would be less likely to elongate under stress and therefore they retain the original shape and dimensions. This would reduce the amount of breaks which are resulted from the film yielding and thinning under load. Also, the printed surface of the bag would not be distorted, maintaining the aesthetic quality of the package and enhancing brand recognition by the consumer.

In addition, the films that do not compromise the aforementioned properties could allow the reduction in the film thickness, further improving the economics associated with the products. Such innovations are desirable to all in the heavy duty shipping sack industry for creating new products that provide both performance and economic benefit.

### SUMMARY OF THE INVENTION

The method of the invention comprises orienting a multilayer film in the machine-direction (MD) at a draw-down ratio effective to give the film a dart-drop strength that increases with increasing draw-down ratio. The multilayer film comprises at least one layer of a linear low density polyethylene (LLDPE) and at least one layer of a high density polyethylene (HDPE) or a medium density polyethylene (MDPE).

When a film is stretched, its dart-drop impact strength usually is reduced as the film becomes thinner. I surprisingly found that when a multilayer film is oriented in the machine direction beyond a certain draw-down ratio, the dart-drop strength of the film increases with increasing draw-down ratio and the oriented film can eventually have a dart-drop value greater than that of the original film. Thus, the invention provides a new method for producing a machine-direction oriented (MDO) multilayer film which has a combination of high modulus, high tensile, and high dart-drop impact strength.

### DETAILED DESCRIPTION OF THE INVENTION

The method of the invention comprises orienting a multilayer film in the machine-direction (MD) at a draw-down ratio effective to give the film a dart-drop strength that increases with increasing draw-down ratio. The multilayer film comprises at least one layer of a linear low density polyethylene (LLDPE) and at least one layer of a high density polyethylene (HDPE) or a medium density polyethylene (MDPE).

Suitable LLDPE preferably is copolymers of ethylene with 5 wt % to 15 wt % of a long chain α-olefin such as 1-butene, 1-hexene, and 1-octene. Suitable LLDPE includes those which have a density within the range of about 0.910 g/cm³ to about 0.925 g/cm³. Suitable LLDPE also includes the so called very low density polyethylene (VLDPE). Suitable VLDPE has a density within the range of 0.865 g/cm³ to 0.910 g/cm³.

Suitable MDPE preferably has a density within the range of about 0.926 g/cm³ to about 0.940 g/cm³. More preferably, the density is within the range of about 0.930 g/cm³ to about 0.940 g/cm³. Preferred MDPE is a copolymer that comprises from about 85 wt % to about 98 wt % of recurring units of ethylene and from about 2 wt % to about 15 wt % of recurring units of a C₃ to C₁₀ α-olefin. Suitable C₃ to C₁₀ α-olefins include propylene, 1-butene, 1-pentene, 1-hexene, 4-methyl-1-pentene, and 1-octene, and the like, and mixtures thereof.

Preferably, the MDPE has a bimodal or multimodal molecular weight distribution. Method for making bimodal or multimodal MDPE is known. For instance, U.S. Pat. No. 6,486,270, the teachings of which are herein incorporated by reference, teaches the preparation of MDPE by a multiple-zone process.

Suitable HDPE preferably has a density within the range of about 0.941 g/cm³ to about 0.970 g/cm³. More preferably, the density is within the range of about 0.945 g/cm³ to about 0.965 g/cm³. Most preferably, the density is within the range of 0.958 g/cm³ to 0.962 g/cm³.

Preferably, the LLDPE, MDPE and HDPE have an MI₂ from about 0.01 to about 1.5 dg/min, and more preferably from about 0.01 to about 1.0 dg/min. Preferably, the LLDPE, MDPE and HDPE have an MFR from about 50 to about 300. Melt index (MI₂) is usually used to measure polymer molecular weight, and melt flow ratio (MFR) is used to measure the molecular weight distribution. A larger MI₂ indicates a lower molecular weight. A larger MFR indicates a broader molecular weight distribution. MFR is the ratio of the high-load melt index (HLMI) to MI₂. The MI₂ and HLMI can be measured according to ASTM D-1238. The MI₂ is measured at 190° C. under 2.16 kg pressure. The HLMI is measured at 190° C. under 21.6 kg pressure.

Preferably, the LLDPE, MDPE, and HDPE have a number average molecular weight (Mn) within the range of about 10,000 to about 500,000, more preferably from about 11,000 to about 50,000, and most preferably from about 11,000 to about 35,000. Preferably, the LLDPE, MDPE, and HDPE have a weight average molecular weight (Mw) within the range of about 120,000 to about 1,000,000, more preferably from about 135,000 to about 500,000, and most preferably from about 140,000 to about 250,000. Preferably, the LLDPE, MDPE, and HDPE have a molecular weight distribution (Mw/Mn) within the range of about 3 to about 20, more preferably from about 4 to about 18, and most preferably from about 5 to about 17.

The Mw, Mn, and Mw/Mn are obtained by gel permeation chromatography (GPC) on a Waters GPC2000CV high temperature instrument equipped with a mixed bed GPC column (Polymer Labs mixed B-LS) and 1,2,4-trichlorobenzene (TCB) as the mobile phase. The mobile phase is used at a nominal flow rate of 1.0 mL/min and a temperature of 145° C. No antioxidant is added to the mobile phase, but 800 ppm BHT is added to the solvent used for sample dissolution. Polymer samples are heated at 175° C. for two hours with gentle agitation every 30 minutes. Injection volume is 100 microliters.

The Mw and Mn are calculated using the cumulative matching % calibration procedure employed by the Waters Millennium 4.0 software. This involves first generating a calibration curve using narrow polystyrene standards (PSS, products of Waters Corporation), then developing a polyethylene calibration by the Universal Calibration procedure.

Suitable LLDPE, MDPE, and HDPE can be produced by Ziegler, single-site, or any other olefin polymerization catalysts. Ziegler catalysts are well known. Examples of suitable Ziegler catalysts include titanium halides, titanium alkoxides, vanadium halides, and mixtures thereof. Ziegler catalysts are used with cocatalysts such as alkyl aluminum compounds.

Single-site catalysts can be divided into metallocene and non-metallocene. Metallocene single-site catalysts are transition metal compounds that contain cyclopentadienyl (Cp) or Cp derivative ligands. For example, U.S. Pat. No. 4,542,199, the teachings of which are incorporated herein by reference, teaches metallocene catalysts. Non-metallocene single-site catalysts contain ligands other than Cp but have the same catalytic characteristics as metallocenes. The non-metallocene single-site catalysts may contain heteroatomic ligands, e.g., boraaryl, pyrrolyl, azaborolinyl or quinolinyl. For example, U.S. Pat. Nos. 6,034,027, 5,539,124, 5,756,611, and 5,637,660, the teachings of which are incorporated herein by reference, teach non-metallocene catalysts.

Optionally, the multilayer film comprises other layers such as gas-barrier, adhesive, medical, flame retardant layers, and the like. Suitable materials for the optional layers include poly(vinylidene chloride), poly(vinyl alcohol), polyamide (Nylon), polyacrylonitrile, ethylene-vinyl acetate copolymers (EVA), ethylene-methyl acrylate copolymers (EMA), ethylene-acrylic acid copolymers (EAA), ionomers, maleic anhydride grafted polyolefins, K-resins (styrene/butadiene block copolymers), and poly(ethylene terephthalate) (PET), the like, and mixtures thereof.

The multilayer films can be made by co-extrusion, coating, and any other laminating processes. They can be made by casting or blown film processes. Blown film process includes high-stalk and in-pocket processes. The difference between the high-stalk process and the in-pocket process is that in the high-stalk process, the extruded tube is inflated a distance (i.e., the length of the stalk) from the extrusion die, while the extruded tube in the in-pocket process is inflated as the tube exits the extrusion die.

The multilayer film is uniaxially stretched in the machine (or processing) direction. This is so called MDO. During the MDO, the film from the blown-film line or other film process is heated to an orientation temperature. Preferably, the orientation temperature is between 60% of the difference between the glass transition temperature (Tg) and the melting point (Tm) and the melting temperature (Tm). For instance, if the blend has a Tg of 25° C. and a Tm of 125° C, the orientation temperature is preferably within the range of about 60° C. to about 125° C. The heating is preferably performed utilizing multiple heating rollers.

Next, the heated film is fed into a slow draw roll with a nip roller, which has the same rolling speed as the heating rollers. The film then enters a fast draw roll. The fast draw roll has a speed that is 2 to 10 times faster than the slow draw roll, which effectively stretches the film on a continuous basis.

The stretched film then enters annealing thermal rollers, which allow stress relaxation by holding the film at an elevated temperature for a period of time. The annealing temperature is preferably within the range of about 100° C. to about 125° C. and the annealing time is within the range of about 1 to about 2 seconds. Finally, the film is cooled through cooling rollers to an ambient temperature.

The ratio of the film thickness before and after orientation is called “draw-down ratio.” For example, when a 6-mil film is stretched to 0.6-mil, the draw-down ratio is 10:1. According to the method of the invention, the draw-down ratio is sufficiently high at which the dart-drop strength of the film increases with the draw-down ratio. As expected, when the multilayer film is MD-oriented, its dart-drop value decreases with increasing draw-down ratio. However, I surprisingly found that when the film is oriented beyond a certain point, the dart-drop value increases with draw-down ratio. As the orientation continues, the oriented film can have an ultimate dart-drop value greater than that of the un-oriented film.

The critical point beyond which the dart-drop value increases with draw-down ratio depends on many factors, including the properties of the layers, the film process conditions and the MDO conditions. Preferably, the draw-down ratio is greater than 6:1. More preferably, the draw-down ratio is greater than 8:1. Most preferably, the draw-down ratio is greater than 10:1. Preferably, the multilayer film is oriented to an extent that the layers of the film start delaminating and forming a multi-wall film.

The invention includes the MD oriented film made by the method of the invention. The invention also includes the multi-wall film made by the method of the invention. The film of the invention not only has a high modulus and high tensile strength, but also has high dart-drop impact strength. The film of the invention is particularly useful for making heavy-duty bags due to its combination of high modulus, high tensile and high impact strength.

Preferably, the film of the invention has a 1% secant MD and TD (transverse direction) modulus greater than 150,000 psi, more preferably greater than 200,000 psi, and most preferably greater than 250,000 psi. Modulus is tested according to ASTM E-111-97.

Preferably, the film has an MD tensile strength at yield and at break greater than 30,000 psi, more preferably greater than 35,000 psi, and most preferably greater than 40,000 psi. Tensile strength is tested according to ASTM D-882.

Preferably, the film has a haze less than 50%, and more preferably less than 30%. The haze is tested according to ASTM D1003-92: Standard Test Method for Haze and Luminous Transmittance of Transparent Plastics, October 1992. Preferably, the film has a gloss greater than 20, and more preferably greater than 30. The gloss is tested according to ASTM D2457-90: Standard Test Method for Specular Gloss of Plastic Films and Solid Plastics.

The following examples merely illustrate the invention. Those skilled in the art will recognize many variations that are within the spirit of the invention and scope of the claims.

### EXAMPLES 1-6

### Machine Direction Orientation of LLDPE/MDPE/LLDPE Three-Layer Films

A medium density polyethylene (XL3805, product of Equistar Chemicals, LP, MI₂: 0.057 dg/min, density: 0.938 g/cm³, Mn: 18,000, Mw: 209,000) is coextruded with a linear low density polyethylene (GS707, product of Equistar Chemicals, LP, density: 0.915 g/cm³, MI₂: 0.700 dg/min, Mn: 30,000, Mw: 120,000) and converted into an equally layered three layer (LLDPE/MDPE/LLDPE) film with a thickness of 14.0 mil on 1000 mm die with 2.5 mm die gap. The films are produced in the pocket and at blow-up ratios (BUR) of 2:1.

The films are then stretched into thinner films in the machine direction with draw-down ratios 4, 5, 6, 7, 8 and 9.3:1 in Examples 1-6, respectively. The draw-down ratio of 9.3:1 is the maximum draw-down ratio limited by the orientation equipment and not the polymer film. The film properties are listed in Table 1. It is shown that at lower draw ratios, the dart drop values decrease with increasing draw-down ratios as expected. After a particular draw ratio, the dart drop values begin to increase and significantly exceed that dart drop value of the initial film.

TABLE 1
Properties vs. Draw-down Ratio of Multilayer Films

| | | Dart | | | | | | |
|---|---|---|---|---|---|---|---|---|
| | Draw- | Drop | MD | TD | MD Tensile | MD Tensile | | |
| Ex. | Down | F50 | Modulus | Modulus | Strength @ Yield | Strength @ Break | | Haze |
| No. | Ratio | Grams | kpsi | kpsi | kpsi | kpsi | Gloss | % |
| 1 | 4:1 | 136 | 122 | 149 | 8.85 | 13.8 | 22 | 39 |
| 2 | 5:1 | 128 | 144 | 155 | 16.5 | 20.2 | 26 | 34 |
| 3 | 6:1 | 134 | 170 | 160 | 24.3 | 26.7 | 29 | 31 |
| 4 | 7:1 | 155 | 200 | 164 | 32.0 | 33.0 | 31 | 30 |
| 5 | 8:1 | 190 | 236 | 167 | 39.5 | 39.5 | 32 | 30 |
| 6 | 9.3:1 | 258 | 293 | 171 | 47.9 | 47.9 | 31 | 33 |

### COMPARATIVE EXAMPLES 7-11

### Machine Direction Orientation of HDPE Monolayer Films

Examples 1-6 are repeated, but the films are made as a monolayer HDPE structure (L5005, product of Equistar Chemicals, LP, density: 0.949 g/cm³, MI₂: 0.057 dg/min, Mn: 12,600, Mw: 212,000). The film properties are listed in Table 2, which shows that the dart drop values significantly decrease with increasing draw-down ratio and the drastic upturn in dart drop values seen with the multilayer films in Examples 1-6 is not observed. The draw-down ratio of 7.9:1 is the maximum draw-down ratio limited by the orientation equipment and not by the polymer film.

TABLE 2
Properties vs. Draw-down Ratio of Monolayer Films

| | Draw- | Dart Drop | MD | TD | MD Tensile | MD Tensile | | |
|---|---|---|---|---|---|---|---|---|
| Ex. | Down | F50 | Modulus | Modulus | Strength @ Yield | Strength @ Break | | Haze |
| No. | Ratio | Grams | kpsi | kpsi | Kpsi | kpsi | Gloss | % |
| C7 | 4:1 | 137 | 218 | 234 | 6.53 | 15.3 | 12 | 60 |
| C8 | 5:1 | 105 | 239 | 236 | 7.17 | 20.1 | 14 | 56 |
| C9 | 6:1 | 86 | 261 | 238 | 7.81 | 25.0 | 16 | 52 |
| C10 | 7:1 | 81 | 286 | 240 | 8.45 | 29.8 | 19 | 48 |
| C11 | 7.9:1 | 88 | 310 | 241 | 9.02 | 34.1 | 23 | 44 |

### COMPARATIVE EXAMPLES 12-19

### Machine Direction Orientation of Monolayer Films From MDPE-LLDPE Blend

Examples 1-6 are repeated, but the films that are made as monolayer from the blend of MDPE (XL3805, product of Equistar Chemicals, LP, MI₂: 0.057 dg/min, density: 0.938 g/cm³, Mn: 18,000, Mw: 209,000) and LLDPE (GS707, product of Equistar Chemicals, LP, density: 0.915 g/cm³, MI₂: 0.700 dg/min, Mn: 30,000, Mw: 120,000). The components in the blend have ratios so that the percentage of each material present in the overall film is the same as that of the multilayer films represented in Examples 1-6. The film properties are listed in Table 3, which shows that the dart drop values significantly decrease with increasing draw-down ratio and the drastic upturn seen with the multilayer films in Examples 1-6 is not observed. The draw-down ratio of 10.6:1 is the maximum draw-down ratio limited by the orientation equipment and not by the polymer film.

TABLE 3
Properties vs. Draw-down Ratio of Monolayer MDPE-LLDPE Blend Films

| | | Dart | | | | | | |
|---|---|---|---|---|---|---|---|---|
| | Draw- | Drop | MD | TD | MD Tensile | MD Tensile | | |
| Ex. | Down | F50 | Modulus | Modulus | Strength @ Yield | Strength @ Break | | Haze |
| No. | Ratio | Grams | kpsi | kpsi | kpsi | kpsi | Gloss | % |
| C12 | 4:1 | 140 | 104 | 129 | 7.32 | 13.4 | 27 | 32 |
| C13 | 5:1 | 120 | 120 | 135 | 12.2 | 17.5 | 30 | 29 |
| C14 | 6:1 | 105 | 139 | 140 | 17.1 | 21.6 | 34 | 27 |
| C15 | 7:1 | 93 | 161 | 145 | 22.1 | 25.7 | 36 | 25 |
| C16 | 8:1 | 87 | 186 | 148 | 27.0 | 29.9 | 38 | 24 |
| C17 | 9:1 | 84 | 215 | 151 | 32.0 | 34.0 | 39 | 24 |
| C18 | 10:1 | 86 | 249 | 154 | 36.9 | 38.1 | 39 | 25 |
| C19 | 10.6:1 | 89 | 272 | 156 | 39.9 | 40.5 | 9 | 26 |

1. A method comprising orienting a multilayer film in the machine direction at a draw-down ratio effective to give the film a dart-drop strength that increases with increasing draw-down ratio, wherein the film comprises at least one layer of a linear low density polyethylene (LLDPE) and at least one layer of a high density polyethylene (HDPE) or a medium density polyethylene (MDPE).

2. The method of claim 1 wherein the HDPE has a density within the range of 0.941 g/cm³ to 0.970 g/cm³.

3. The method of claim 1 wherein the MDPE has a density within the range of 0.926 g/cm³ to 0.940 g/cm³.

4. The method of claim 1 wherein the LLDPE has a density within the range of 0.865 to 0.925 g/cm³.

5. The method of claim 1 wherein the film is oriented at a draw-down ratio effective to cause the film delaminating.

6. The method of claim 1 wherein the film is oriented at a draw-down ratio to give the film a dart-drop strength greater than that of the original film.

7. The method of claim 1 wherein the LLDPE, HDPE, and MDPE each has a weight average molecular weight (Mw) within the range of 120,000 to 1,000,000.

8. The method of claim 7 wherein the Mw is within the range of 135,000 to 500,000.

9. The method of claim 7 wherein the Mw is within the range of 140,000 to 250,000.

10. The method of claim 1 wherein the LLDPE, HDPE, and MDPE each has a number average molecular weight (Mn) within the range of 10,000 to 500,000.

11. The method of claim 10 wherein the Mn is within the range of 11,000 to 50,000.

12. The method of claim 10 wherein the Mn is within the range 11,000 to 35,000.

13. An oriented film made by the method of claim 1.

14. A multi-wall film made by the method of claim 5.
